(19) United States
(12) Patent Application Publication
(10) Pub. No.: US 2008/0089786 A1
(43) Pub. Date: Apr. 17, 2008

(54) Counter-Rotating Integrated Propeller Assembly

(76) Inventor: Mark G. Sinreich, Akron, OH (US)

Correspondence Address: RANKIN, HILL & CLARK LLP, 925 EUCLID AVENUE, SUITE 700, CLEVELAND, OH, 44115-1405, US

(21) Appl. No.: 11/550,262

(22) Filed: Oct. 17, 2006

(51) Int. Cl. B64C 11/48

(52) U.S. Cl. 416/129

(57) ABSTRACT

A multiple counter-rotating propeller assembly includes a drive shaft, a first propeller and a second propeller. The first propeller has a first hub which is supported on the drive shaft and which is freely rotatable with respect to the drive shaft, a plurality of first blades mounted on the hub, and a gear set connected to the drive shaft and to the hub, the gear set rotating the hub in a direction opposite to the direction of rotation of the drive shaft. The second propeller has a second hub which is supported on the drive shaft and which is freely rotatable with respect to the drive shaft, and a plurality of second blades mounted on the second hub, the second hub connected to the gear set in the first hub to rotate the second hub in the same direction as the rotation of the drive shaft. The entire propeller assembly is supported solely on the drive shaft, and the inclusion of the gear set which provides all of the gear reduction completely within the propeller hub provides a compact design.

### FIELD OF INVENTION

The present invention relates to marine propulsion systems comprising dual counter-rotating propellers, and more particularly, to transmission of power from a drive shaft to the propellers.

### BACKGROUND OF THE INVENTION

Marine propulsion systems that include counter-rotating propellers are well known. Among the advantages of these systems is their efficiency, particularly at high speeds and high thrusts, resulting in lower fuel costs. When two propellers are used, it is also possible to reduce the diameters of the propellers, which can provide a more compact design. Dual propellers also offset torque imbalance which result from the use of a single propeller.

Examples of counter-rotating propeller marine propulsion systems are shown in U.S. Pat. No. 2,543,453, issued to Fuller; U.S. Pat. No. 3,087,553, issued to Kostyun; U.S. Pat. No. 4,074,652, issued to Jackson; U.S. Pat. No. 4,360,348, issued to DeMarco;: U.S. Pat. No. 4,540,369, issued to Caires; U.S. Pat. No. 4,604,032, issued to Brandt et al.; U.S. Pat. No. 4,619,584 issued to Brandt; U.S. Pat. No. 5,009,621, issued to Bankstahl et al.; U.S. Pat. No. 5,017,168 issued to Ackley; U.S. Pat. No. 5,030,149, issued to Fujita; U.S. Pat. No. 5,087,230, issued to Yates et al.; U.S. Pat. No. 5,185,545, issued to Veronesi et al.; U.S. Pat. No. 5,556,313, issued to Ogino; U.S. Pat. No. 5,597,334, issued to Ogino; U.S. Pat. Nos. 5,599,215, 5,601,464, issued to Ogino et al.; issued to Järvinen; U.S. Pat. No. 5,800,223, issued to Iriono et al.; U.S. Pat. No. 5,890,938 issued to Eick et al.; U.S. Pat. No. 6,186,922, issued to Bursal et al.; U.S. Pat. No. 6,220,906 issued to Dubois; and U.S. Pat. No. 6,478,641 issued to Jordan.

While these systems have their advantages, they also have had many important disadvantages, particularly their complexity, weight and cost. The prior art counter-rotating propeller systems usually required a complex gear box, often with precision cut steel gears, inside the vessel. Highly specialized and expensive engines, transmissions and propulsion systems had to be purchased to utilize the advantages of the counter-rotating propeller feature. Many of these systems utilized concentric counter-rotating shafts that extended through the vessel hull, with complex bearings, bushings and seals. Because of their complexity, an oil-filled transmission was often required, which could leak oil and create an environmental problem. As a result, these prior art systems generally have not been suitable for many applications, particularly for small craft and smaller yachts.

Therefore, it would be desirable to provide a simple counter rotating propeller assembly that can be used in a variety of applications, and is especially adaptable for use with smaller vessels.

It would also be desirable to provide a propeller system which can take advantage of hybrid or electric propulsion systems. Hybrid propulsion systems, which utilize diesel generators that power electric motors, have found broad acceptance in large ships, but they have not been feasible in smaller craft for technical or economic reasons. While great advances have been made in highly reliable, permanent magnet brushless direct-current (BLDC) motors and other electric motor technologies that have great promise for hybrid propulsion, attempts to apply them to small craft have found limited success. Electric propulsion systems take advantage of advances in high energy density lithium and other battery technologies, often in combination with solar, fuel cell and other alternate electric energy sources.

The application of hybrid propulsion to small craft has been hampered in part by the fundamental mismatch between optimal propeller speed and optimal motor speed. A propeller is most effective turning at relatively slow speeds, e.g. 500 to 2,500 rpm, but a BLDC motor has peak efficiency and power density at speeds from 3,000 to 10,000 rpm. Prior efforts to create a BLDC motor that runs at slower propeller speeds have resulted in motors that are many times larger and heavier than they otherwise need to be. A large motor with large surface area is also needed to dissipate the heat loss generated by the motor into the surrounding air, and a large motor needs to be placed inside the hull, requiring an engine room, motor mounts, stern shaft, stern tube, bearings, seals, shaft supports, the risk of water leaks and all of the heavy and expensive structure that current diesel engines require. Attempts to use forced water cooling for the heat removal in BLDC motors have added complexity, cost, weight and the risk of water intrusion and sinking. Forced water cooling does not eliminate the need for the interior space, stern shaft, weight and cost of a traditional marine propulsion system.

Attempts to solve many of these problems by putting the electric motor in a pod in the water outside the vessel have been successful in very large commercial vessels such as cruise ships, but have not found success in smaller vessels, due to the mismatch between the optimal motor speed and optimal propeller speed. To achieve a small diameter motor suitable for use in a small craft pod, the motor power was reduced. To run such a smaller motor at low enough speeds to directly drive a propeller further wasted a majority of the power potential of the motor. Another prior attempt at solving the problem was to squeeze a gear reduction package onto the end of the motor in the pod, but this required an oil-filled integrated gear box, with complex seals to prevent leaks of oil into the environment. This complex solution has not scaled to smaller craft which have efficiency requirements and cost limitations.

### SUMMARY OF INVENTION

The present invention overcomes these problems, and provides a unique and advantageous propeller assembly having two or more counter rotating propellers. The propeller assembly of the present invention is particularly suitable for use with smaller watercraft, since it can be advantageously used with hybrid or electric propulsion systems. In addition, the present invention is adaptable for use with a wide variety of other propulsion systems. The propeller assembly can be attached directly to the drive shaft of a variety of outboard motors, to inboard motor shafts, or directly to electric motor shafts, running at tops speeds ranging from 1,000 to 10,000 rpm or more.

The propeller assembly of the present invention provides dual counter rotating propellers, which provide optimal propulsive efficiency, with the downstream propeller recovering much of the downstream radial swirl created by the upstream propeller. While the invention provides for two propellers, any number of multiple propellers can be included into a propeller assembly in accordance with this invention. Additional propellers can be provided, all supported on the same motor drive shaft.

The propeller assembly of the present invention avoids the use of concentric drive shafts to achieve the dual counter rotating propeller, which when protruding through the vessel hull have sealing problems, require complex bearings and a costly internal gear box, and otherwise add to the cost, weight and complexity of the propeller system. It also avoids the addition of an in-line gear box after the drive shaft, with resulting couplings, bearings, shafts, supports, weight and cost.

With the present invention, the propeller hubs are installed directly on the drive shaft with all necessary gearing and bearings contained completely with the hubs, avoiding any external gearing assemblies. The propeller assembly is especially well adapted for retrofitting on existing drive shafts, since it is self-contained and requires no additional attachments or any modification of the existing power train. Units can be preassembled and installed on or over existing drive shafts without any mechanical connection to the hull or any other structure, strut or support.

Another advantage of the present invention is that neither of the propellers is directly coupled to the drive shaft, nor does any propeller rotate at the speed of the drive shaft. This allows the propeller assembly to be installed on drive shafts connected to high speed propulsion systems. Instead of being directly connected to the drive shaft, each propeller spins freely on bearings riding on and solely supported by the drive shaft. The propeller assembly includes appropriate gearing, so that both propellers turn at optimal reduced speed with respect to the drive shaft. The speed reduction of the motor drive shaft to match optimal propeller speed is performed by gear reduction internal to the propeller hubs, offering a wide range of gear ratios. The gear reduction also provides different speed ratios for each propeller, optimizing the effects of upstream and downstream slipstream velocities, and allowing further optimization of propeller diameter, pitch, and blade shape.

In accordance with the present invention, the speed reduction is accomplished by gears that are optimally integrated into the hubs of the propellers and supported entirely on the drive shaft, resulting in a compact design that avoids the necessity of in-line transmissions, gear boxes, support struts or other vessel mounted structures, saving substantially on cost and size. The gears are preferably a planetary gear set, providing reliable operation, which is compact and can be completely contained within the propeller hub. However, other gear configurations that accomplish the same results can be used. Further, a simple single stage gear reduction can be used, or compound gearing can be used, or multiple-stage gearing can be used, to gain higher or lower gear reduction ratios.

The propeller assembly of this invention can be lubricated entirely by means of the water in which the propeller assembly operates. To provide water lubrication, the entire assembly is exposed to water, avoiding the need for complex seals or gaskets to retain lubricating oil, and the problems of sealing failures and leaking of lubricating oil which would seep into the environment. Studies have reported that leaks from marine propulsion drive unit oil and lubrication systems pollute the environment with immense quantities of petroleum products every year. Since the assembly can be water lubricated, it is feasible and may even be optimal, to fabricate many of the components of the propeller assembly, such as gears and bearings, of composite materials when the propeller assembly is used with the power levels required by small craft and yachts. To achieve higher power output levels, this invention can utilize oil lubrication as well.

The propeller assembly of the present invention is versatile and can be used in a variety of applications. It can be used with a dual shaft electric motor, with a dual propeller assembly installed on both the forward facing and the aft facing motor shafts, one being in a puller mode, the other being a pusher mode, resulting in a further increase in efficiency. It can be used with ducted propellers, wherein a circumferential duct around each propeller is advantageously used to increase propeller efficiency and total thrust, especially at lower speeds where slower rotating propellers can be most effective. It can be adapted to power levels ranging from 1 HP to 1,000 HP or more, with modifications of materials and gear geometries.

The principals of the present invention can be modified for various specific applications. Modified versions can be created to provide upgrades in the outboard motor market where owners want notably increased thrust and power levels at lower speeds. Modified versions can also be created to provide upgrades to inboard drive shaft applications where owners desire notably increased thrust, power levels, top speed, power out of the hole, and above all fuel efficiency. Further modifications can be made to maximize the potential of the nascent market for hybrid and electric propulsion.

These and other advantages are provided by the present invention of a multiple counter-rotating propeller assembly, which comprises a drive shaft, a first propeller and a second propeller. The first propeller comprises a first hub which is supported on the drive shaft and which is freely rotatable with respect to the drive shaft, a plurality of first blades mounted on the hub, and a gear set connected to the drive shaft and to the hub, the gear set rotating the hub in a direction opposite to the direction of rotation of the drive shaft. The second propeller comprises a second hub which is supported on the drive shaft and which is freely rotatable with respect to the drive shaft, and a plurality of second blades mounted on the second hub, the second hub connected to the gear set in the first hub to rotate the second hub in the same direction as the rotation of the drive shaft.

### BRIEF DESCRIPTION OF THE DRAWINGS

FIG. 1 is a perspective view of the propeller assembly of the present invention shown mounted on a drive shaft extending from a vessel or motor housing.

FIG. 2 is a cross sectional perspective view of the propeller assembly of FIG. 1.

FIG. 3 is cross sectional view of the propeller assembly similar to FIG. 2 but shown in an elevational cross section.

FIG. 4 is an end sectional view of the propeller assembly taken along line 4-4 of FIG. 3.

FIG. 5 is an end sectional view of the propeller assembly taken along line 5-5 of FIG. 3.

FIG. 6 is an exploded view of the propeller assembly of FIG. 1.

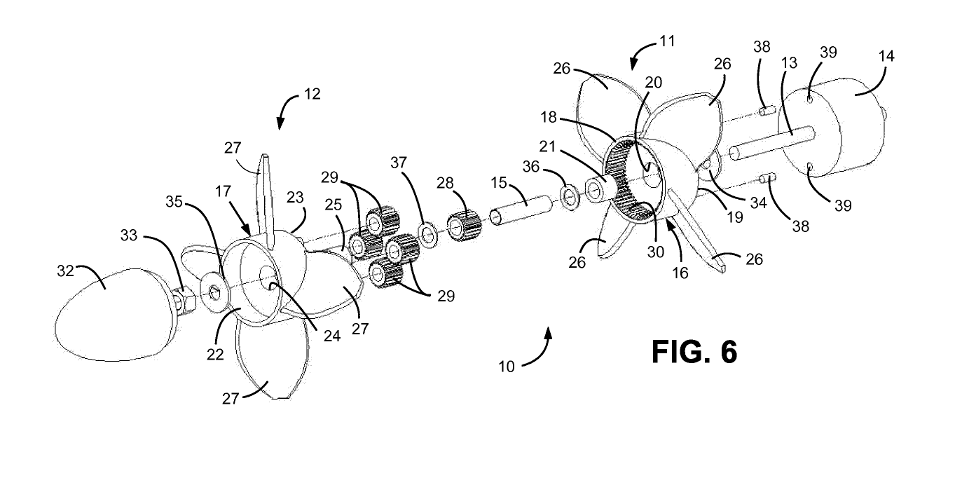

### DETAILED DESCRIPTION OF PREFERRED EMBODIMENTS

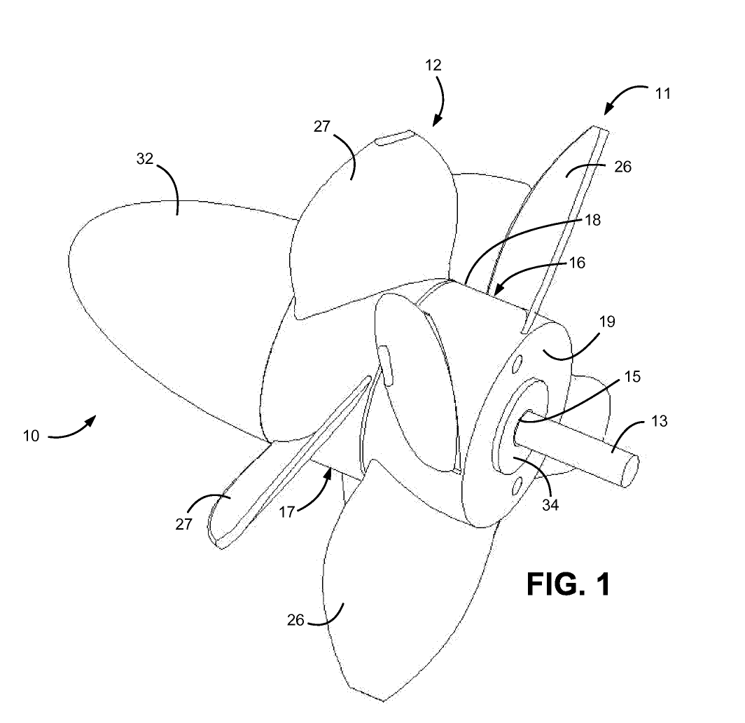

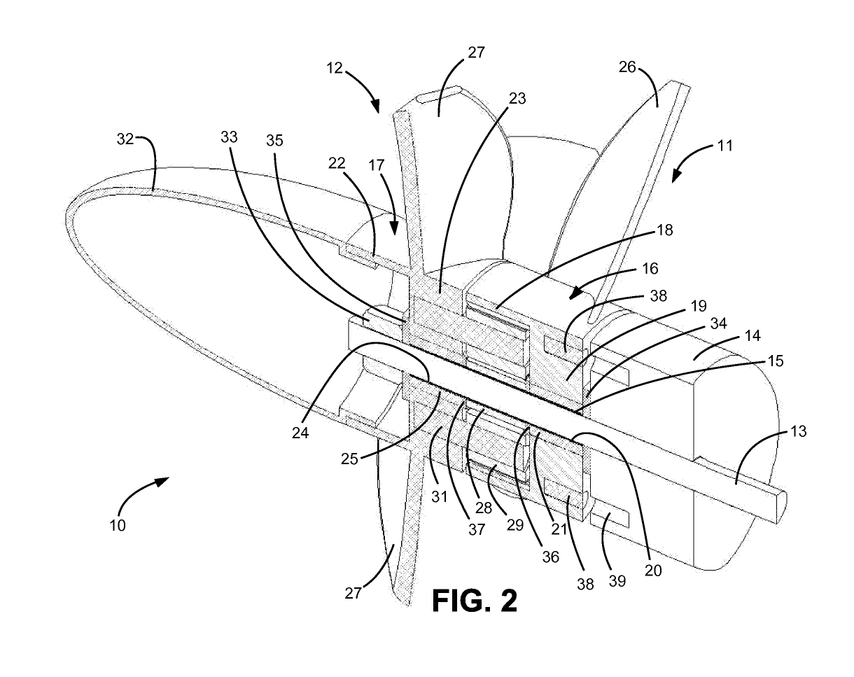

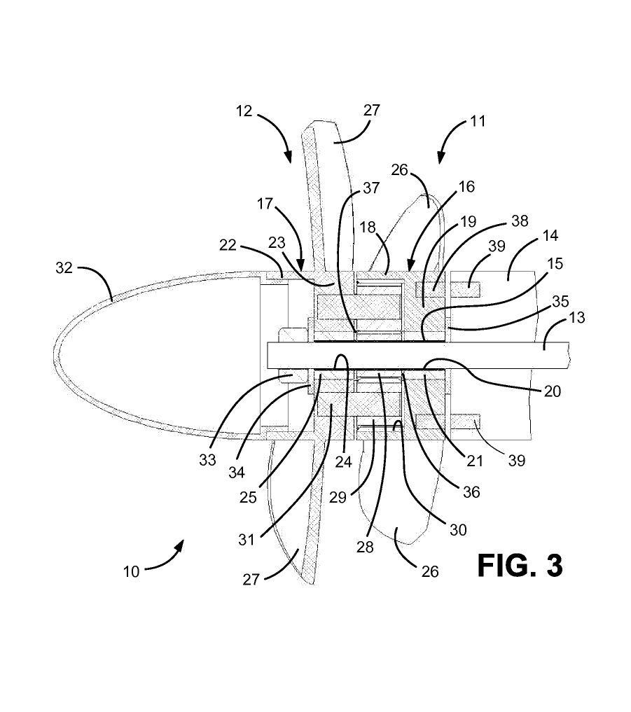

Referring more particularly to the drawings, and initially to FIG. 1, there is shown a propeller assembly 10 according the present invention, comprising a first propeller set 11 and a second propeller set 12. The assembly 10 is mounted on the end of a drive shaft 13 (FIGS. 2 and 3) which extends from a marine vessel or motor housing 14. The drive shaft 13 which is connected to a suitable propulsion system such as an electric motor, may be hollow or solid. The drive shaft 13 extends through a hollow mounting tube 15 which is locked on the draft shaft and rotates with the drive shaft. The hollow mounting tube 15 is provided only as a convenience allowing the dual propeller system to be assembled prior to its installation on the drive shaft 13. It is also contemplated that the components of the assembly, including gearing, bearings, hubs and propellers, can be directly mounted to the drive shaft 13. Each of the propeller sets 11 and 12 has a hollow cylindrical hub 16 and 17, respectively. The first hub 16 is positioned directly adjacent to the vessel or electric motor housing 14 from which the drive shaft 13 extends, and the second hub 17 is position directly adjacent to the first hub.

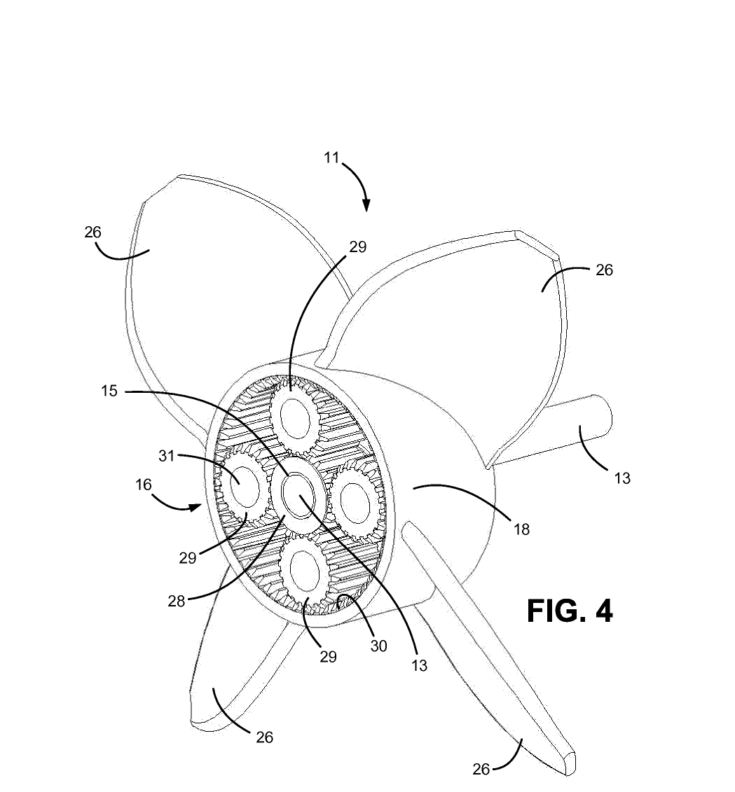

As shown in FIGS. 2, 3 and 4, the first propeller hub 16 comprises an annular outer circumferential rim portion 18 and a circular disk portion 19. The disk portion 19, which extends radially adjacent to the vessel or motor housing 14, has a central opening 20 through which the mounting tube 15 extends. Suitable bearings 21 are provided in the opening 20 between the mounting tube 15 and the disk portion 19, so that the first hub 16 is supported entirely on the mounting tube but rotates free of mounting tube and drive shaft rotation.

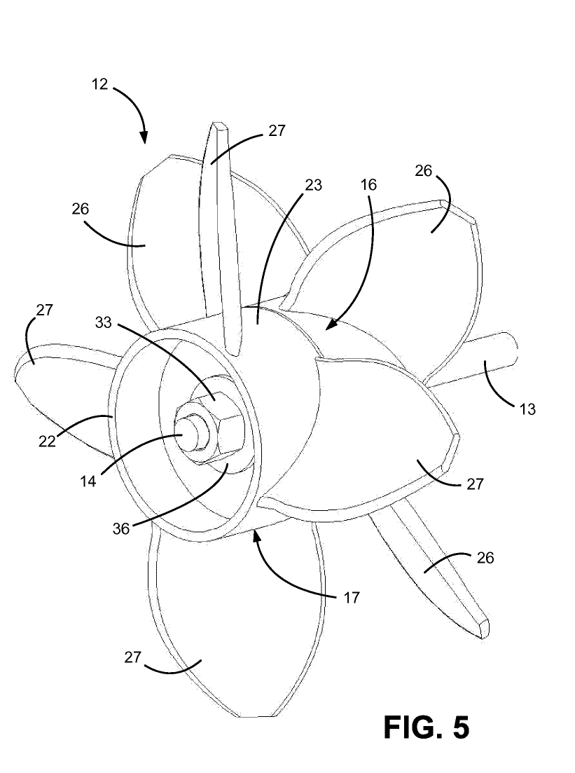

As shown in FIGS. 2, 3 and 5, the second propeller hub 17 has a configuration generally similar to the first hub 16. It includes an outer annular circumferential rim portion 22 and a circular disk portion 23. The disk portion extends axially adjacent to the first hub 16. The disk portion 23 has a central opening 24 by which the second propeller hub 17 is mounted for support on the mounting tube 15. The second hub 17 is freely mounted for rotation on the mounting tube 15 by suitable bearings 25, so that the second hub rotates free of the rotation of the mounting tube and the drive shaft 13.

Preferably, the hubs 16 and 17 have the same outer diameter of the motor housing, so that the rim portions 18 and 22 are flush with each other and with the motor housing for hydrodynamic flow. Alternately, the outer diameters of the hubs 16 and 17 can taper smoothly from the vessel or motor housing to the other end of the hubs, further optimizing hydrodynamic flow.

Attached to the periphery of the circumferential rim portion 18 and 22 of each of the hubs is a plurality of propeller blades 26 and 27. The blades 26 on the first propeller hub 16 are pitched to drive the vessel in one direction when the hub 16 is rotated in the opposite direction as the drive shaft 13, and the blades 27 on the second propeller hub 17 are pitched to drive the vessel in the same direction when the hub 17 is rotated in the same direction as the drive shaft.

Contained within the radial plane of the rim portion 18 of the first hub 16 is an epicyclic or planetary gear set. The gear set includes a sun gear 28 which is longitudinally captured between the disk portion 19 of the first hub 16 and the disk portion 23 of the second hub 17. The sun gear 28 is keyed to fit securely on the mounting tube 15 (or on the drive shaft directly if there is no mounting tube) and to rotate along with the drive shaft. The sun gear 28 engages a plurality of planet gears 29. The interior of the annular rim portion 18 provides a ring gear 30 which engages the planet gears 29. In accordance with conventional planetary gear set operation, the ring gear 30 is driven in the opposite direction from the sun gear 28 at a reduced speed. Thus, the first propeller blades 26 rotate in the direction opposite to the direction of rotation of the mounting tube 15 and the drive shaft 13, at a slower speed than the mounting tube and the drive shaft, but with increased torque.

In accordance with the known design of planetary gearing sets, the number of planet gears 29 may vary between two or five or more, depending on the relative geometries and ratios of the gears. In accordance with known planetary gear set design, there is a gear ratio formula that describes the relative rotational speeds of the sun gear 28, the planet gears 29 and the ring gear 30, thereby describing the relative speeds of the drive shaft 13, the hub 16 and the hub 17. Each of the hubs 16 and 17 turns at a speed that is slower than the drive shaft 13, as a function of the diameters of the sun gear and the planet gears. The present invention contemplates that the propeller assembly 10 can be modified with various numbers and sizes of planet gears to meet various requirements for power level capacity, gear reduction and speed ratio.

The disk portion 23 of the second hub 17 has a plurality of pins 31 extending axially into the interior of the first hub 16. Each of the planet gears 29 is mounted on one of the pins 31. The second hub 17 thus serves as a carrier for the planet gears 29 of the planetary gear set. The planet gears 29 rotate freely on the pins 31, by means of suitable bearing means. Thus, as the planet gears 29 rotate around the sun gear 28 on the mounting tube 15, they drive the planet gears and therefore the second propeller blades 27 in the same direction as the mounting tube and the drive shaft 13. The second propeller set 12 thus rotates in the same direction as the rotation of the mounting tube 15 and the drive shaft 13, but at a slower rotational speed and with increased torque.

The present invention thus uses two outputs from the planetary gear set to turn the two propeller hubs 16 and 17, the first hub 16 driven by the ring gear 30, and the second hub 17 driven by the planet gears 29. It is the nature of planetary gear sets that the first propeller hub 16 with the ring gear 30 turns at a set gear reduction ratio with respect to the sun gear 28, and that the gear reduction ratio is different from the gear reduction ratio of second propeller hub 17 with respect to the sun gear. The first hub 16 has a larger gear reduction ratio than the second hub 17. And thus, in theory, the first hub 16 should rotate slower than the second hub 17. However, planetary gear set provide not only gear reduction but also torque multiplication. The torque multiplication to each hub is identical to the gear ratio for the hub. Therefore, a greater portion of the input torque from the drive shaft 13 is delivered to the first hub 16, and a somewhat lesser amount of the torque is delivered to second hub 17. All three elements of the planetary gear set—the sun gear 28, the planet carrier 23 and the ring gear 30—transfer torque between them, as inputs and outputs simultaneously. Therefore, if one element is held motionless, all torque will transfer between the other two elements with a reduction or multiplication according to the gear ratio between those two elements. If one considers only the gear reduction produced by the planetary gear set, one would think that the fist hub 16 with the greater gear reduction would turn slower than the second hub 17, but this is not the case. As a result of the greater gear reduction, the first hub 16 also receives more torque than the second hub 17.

As the drive shaft 13 turns the sun gear 28, each of the hubs 16 and 17 is forced to turn at the speed where the water resistance matches the torque delivered. The first hub 16, which has the greater torque, will turn faster than the second hub, 17 given similar propeller sets and resistance to rotation through the water. The positions of the first hub 16 and the second hub 17 can be interchanged on the drive shaft 13 by reversing the installation of the entire assembly on the drive shaft so that the second hub 17 is closest to the vessel or motor housing 14. This may be advantageous in some applications for optimization of propeller blades and performance by reversing the amount of torque multiplication delivered to each hub with respect to the flow of water past the assembly.

The propeller blade size and pitch on each hub 16 and 17 can be modified to optimize propeller operation. However, changing the size or pitch or size of the propeller blades on one hub changes the water resistance, which reflects more or less torque back to the other hub, changing the relative speed of the hubs, until the torque delivered to each hub is restored to the ratio determined by the torque multiplication ratio for each hub. With dual concentric counter rotating propeller sets, the downstream propeller set experiences faster water velocity and narrower slip stream due to the acceleration of water by the upstream propeller set. It is possible to modify the blade pitch and diameter to ideally take advantage of these effects, thereby optimally balancing the torque delivered to each hub, and creating a more closely match rotational speed for each propeller set. This will have the effect of optimizing the propeller set for vessel propulsion in one direction, although if the propeller sets are run in the opposite direction, the balancing of torque and speed between the hubs will not be optimal, resulting in less efficient performance.

In addition to the bearings 21 and 25 of the disk portions 19 and 23 supporting the hubs 16 and 17 on the mounting tube 15, the gear set of sun, planet and ring gears 28, 29 and 30 is self-centering, and provides additional support for both hubs.

A hydrodynamically tapered fairing bell 32 can be mounted on the mounting tube 15 adjacent to the end of the second hub 17 to cover the end of the drive shaft 13 and to reduce drag through the water for the assembly. The bell 32 is mounted directly and firmly to propeller hub 17 to rotate with the propeller hub, and may also incorporate bearings in contact with the drive shaft or the mounting tube to provide additional support for the bell and the hub.

The components of the propeller assembly 10 may be made of any suitable material, including metal, plastic or composites, and may be molded or otherwise made, according to strength and cost requirements. Steel may be selectively used where it is needed for strength and corrosion resistance. Composite materials or stainless steel are especially advantageous for many applications due to their corrosion resistance. Composite materials may offer cost advantages.

While not necessary to the basic operation of the present invention, various axial support means may be provided. To maintain the assembly in place along the mounting tube 15, a retaining nut 33 or other retaining device may be installed onto the end of the mounting tube. To support the axial thrust produced by the propeller blades, thrust washers 34 and 35 or bearings may also be used between the first hub 16 and the vessel or motor housing 14 and between the second hub and the retaining nut, and thrust washers 36 and 37 may be used between the sun gear 28 and the bearings 21 and 25.

To protect the propeller assembly 10 from smaller stones or other objects which might enter the gaps between the hubs, the motor, and the end bell, and might enter the gears, circumferential seals may be provided. Such seals should not prevent water from entering the propeller assembly, since water is preferably used as the lubrication for the assembly, and it is expected that water will easily be able to enter the interior portions of the assembly. In the case of a higher power assembly with oil lubrication, such seals would need to prevent oil leaking and water intrusion into the propeller assembly.

Preferably, the entire propeller assembly 10 of hubs, bearings, gearing and blades is assembled onto the hollow mounting tube that can slide onto an existing drive shaft in place of an existing single propeller assembly, simplifying installation and subsequent servicing. This.can be assembled and sold as a unit that includes the mounting tube for attachment to an existing drive shaft or power source. The unit can also be sold without the mounting tube, and can be assembled with the gearing and bearings and installed on an existing drive shaft.

By reversing the operation of the motor, and thus reversing the direction of rotation of the drive shaft 13, the direction of rotation of both propeller sets 11 and 12 is reversed. This can be used to provide reverse thrust for maneuvering the vessel. The reverse thrust provided by the propeller assembly will be less optimal than forward thrust if the pitch and sizing of the blades has been designed to take advantage of the different speeds and difference in torque of the propeller sets delivered in forward thrust. However, since reverse operation of the propeller assembly is infrequently used, the decreased effectiveness of the propeller assembly in this mode of operation is not a significant disadvantage. This is a feature that can be chosen by each end user to suit the best needs of each application.

Various modifications may be made to the embodiment just described. For example, if the drive motor has a drive shaft that extends from both ends of the motor, the propeller assembly 10 may be installed on one end or both ends of the drive shaft in coaxial alignment, providing increased thrust and power transfer from motor to water, with smaller diameter blades than would otherwise be necessary. It is also possible to mount two or more propeller assemblies axially in line with each other on the same drive shaft, providing four or more propeller sets, each rotating in alternating directions.

The propeller assembly 10 may also be mounted on the drive shafts of vessels with outboard or inboard motor configurations. The motor that drives the propeller assembly may be a conventional internal combustion engine running on gasoline or diesel or may be an electric motor powered by an engine or by batteries.

In addition to the gear reduction provided by the planetary gear set, other gear configurations can be added to the propeller assembly 10 in order to provide for further gear reduction. For example, compound gearing or multiple-stage gearing can be used to gain higher or lower gear reduction ratios.

Depending upon specific application requirements, the propeller assembly of the present invention may be installed facing aft so that it “pushes” the vessel forward, or facing forward so that it “pulls” the vessel. Puller configurations are more efficient, but they expose the propeller assembly to damage from objects in the water. Pusher configurations are less efficient, but they protect the propeller assembly because any objects in the water are pushed aside by the vessel. In a pusher configuration, the propeller assembly can be further protected by the addition of a skeg protruding below the lower surface of the motor to block objects in the water from striking the propeller blades. The propeller assembly may be mounted at the rear of the vessel, in either pusher or puller configuration, or at the front of the vessel, for unusual propulsion configurations especially those utilizing multiple propulsion units.

While the invention is described as using two propeller sets 11 and 12, it should be understood that more propeller sets may be added. The assembly can consist of four or six propeller sets or more, with each propeller set rotating in the opposite direction as the adjacent propeller set.

The blades on the propeller hubs may be removable to allow for different sized blades to be used on each hub with respect to the other hubs. In addition, the blades may be mounted such that the pitch of the blades can be adjusted. The removable blades also facilitate blade replacement in case of damage due to collision or other failure.

The use of a planetary gear set in the present invention provides two different 3-way relationships between the drive shaft 13 as input and the two sets of propeller blades 26 and 27 as outputs in this invention. These inputs and outputs are actually bidirectional, where each can be an input or output or both, depending on where the force is applied. To understand this relationship, the power input provided by the drive shaft 13 and the power outputs of each of the two propeller sets 11 and 12 can be called “ports.” The speed relationship between the three ports is fixed, in a complex way, such that if any one port is locked motionless, a fixed speed reduction ratio and inverse torque multiplication ratio exists between the other two ports. If one port is turned as an input, then either or both of the other two ports will turn as outputs. If two ports are turned as an input, the third port will turn as the sum or difference of the speeds of the input ports and their respective gear ratios to the third output. Two of the three ports turn in the same direction, and the third turns in the opposite direction. The present invention takes advantage of all of these behaviors.

Further, all three ports share torque applied to any of the ports as an input, or seen as resistance at any of the ports as an output. If the drive shaft 13 turned by the motor is the input, both output ports, the propeller sets 11 and 12, attempt to turn in opposite directions. As the propeller sets attempt to turn, the resistive force of the water is reflected back into the system. Both propeller sets will therefore reflect their water resistance back to the other, and balance these forces equally, given identical propeller sets. This balancing of torque will largely offset the differing gear reduction ratios of each hub, and allow the propeller sets to turn at near equal speeds given identical propeller sets and hydrodynamic influences.

However, as previously noted, the downstream propeller set experiences faster surrounding water velocity than the upstream propeller set. The downstream propeller set will therefore exert less force against the already faster moving water than the upstream propeller set, except that, because of torque balancing, the greater force experienced by the upstream propeller set will be reflected to the upstream propeller set and will cause the upstream propeller set to speed up until it is applying equal force to accelerate the faster moving water, as the force applied by the downstream propeller set. In this manner, the torque-sharing nature of this system will automatically balance the work performed by each propeller set and will to some extent compensate for differences in propeller configuration, direction, and hydrodynamic effects, resulting in self-optimizing performance. It is, therefore, advantageous to alter the size, pitch and shape of the propeller blades relative to each other to take advantage of the hydrodynamic flows. This will make the invention more efficient, but only in forward direction not in reverse, but that is a desirable trade-off.

As a result of the torque sharing behavior between all three ports of the invention, when the vessel is propelled through the water by other means such as sail and wind power, the flow of the water over the propeller blades of the first and second hubs will each exert a power generating force onto the third port which is the drive shaft to the motor. It is inherent in the nature of most electric motors that they also function as electrical generators when driven mechanically by their drive shafts. This generating capacity can be used as a power source into a modern hybrid electric propulsion system by charging batteries or powering other vessel systems when wind is available to move the vessel.

Due to the nature of each hub to rotate freely about the drive shaft, and the three-way gear relationship between both hubs and the drive shaft, the rotational speed of each hub as a result of propeller blade and hydrodynamic factors cannot be automatically determined, even if the speed of the drive shaft from the motor or vessel is known. It may be desirable to know the speed of each hub for purposes of initial tuning and optimizing of the critical parameters of propeller blade size, pitch and other design characteristics. It may also be desirable to know the speed of each hub for diagnostic and maintenance purposes in order to detect a damaged propeller blade, bearing failure, external fouling or other fault. The invention provides for means to detect the rotational speed of the first hub by providing one or more magnets 38 on the first hub 16 facing the vessel or motor housing 14, and one or more magnetic sensors 39 located in the face of the vessel or motor housing 14 immediately facing the first hub and approximately the same radial distance from the drive shaft 13, such that each magnetic sensor will be able to detect the presence of one of the magnets in the hub each time it rotates past the sensor. Using electronic signals from the sensors, the rotational speed of the first hub can be determined. The rotational speed of the motor and the drive shaft will be known by the control system as a standard function of standard motor controllers. Because of the three-way gear ratio relationship between both hubs and the drive shaft, the speed of the second hub can be determined once the speeds of the first hub and the drive shaft are known, and thus the operational speed of each of the hubs 16 and 17 can be monitored.

It should be realized that the embodiment described herein is only representative of the invention and is not intended to limit the invention to one particular embodiment as the invention includes all embodiments falling within the scope of the appended claims. Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1. A multiple counter-rotating propeller assembly, which comprises:
a rotatable drive shaft for connection to a power source;
a first propeller set comprising
a first hub supported on the drive shaft, the hub freely rotatable with respect to the drive shaft,
a plurality of first propeller blades mounted on the hub, and
a gear set connected to the drive shaft and to the hub, the gear set rotating the hub in a direction opposite to the direction of rotation of the drive shaft; and
a second propeller set comprising
a second hub supported on the drive shaft, the hub freely rotatable with respect to the drive shaft, and
a plurality of second propeller blades mounted on the second hub,
the second hub connected to the gear set in the first hub to rotate the second hub in the same direction as the rotation of the drive shaft.

2. The propeller assembly of claim 1, wherein the gear set is contained completely within both the first and the second hub.

3. The propeller assembly of claim 1, wherein the gear set is contained completely within the first hub.

4. The propeller assembly of claim 1, wherein the gear set is integral with the first hub.

5. The propeller assembly of claim 1, wherein the gear set comprises a planetary gear set.

6. The propeller assembly of claim 3, wherein the planetary gear set comprises a sun gear mounted on the drive shaft for rotation with the drive shaft, a plurality of planet gears engaging the sun gear, and a ring gear on the first hub engaging the planet gears and rotating the first hub.

7. The propeller assembly of claim 6, wherein the second hub is connected to at least one of the planet gears to rotate the second hub.

8. The propeller assembly of claim 6, wherein the ring gear is located on an inner circumferential wall of the first hub.

9. The propeller assembly of claim 6, wherein the ring gear is formed by a surface of the first hub.

10. The propeller assembly of claim 1, wherein the propeller assembly is water lubricated.

11. The propeller assembly of claim 1, wherein the first and second hubs are supported entirely by the drive shaft.

12. The propeller assembly of claim 11 for a marine vessel, wherein the propeller assembly is connected to the marine vessel by only the drive shaft.

13. The propeller assembly of claim 11 powered by a motor, wherein the propeller assembly is connected to the motor by only the drive shaft.

14. The propeller assembly of claim 1, comprising in addition bearings between the first hub and the drive shaft.

15. The propeller assembly of claim 1, comprising in addition bearings between the second hub and the drive shaft.

16. The propeller assembly of claim 1, comprising in addition a fairing mounted beside the second hub
